(19) United States
(12) Patent Application Publication
(10) Pub. No.: US 2025/0106606 A1
(43) Pub. Date: Mar. 27, 2025

(54) INFORMATION PROCESSING DEVICE AND METHOD

(71) Applicant: TOYOTA JIDOSHA KABUSHIKI KAISHA, Toyota-shi (JP)

(72) Inventor: Tatsunori KATOH, Nagoya-shi (JP)

(73) Assignee: TOYOTA JIDOSHA KABUSHIKI KAISHA, Toyota-shi (JP)

(21) Appl. No.: 18/884,652

(22) Filed: Sep. 13, 2024

(30) Foreign Application Priority Data
Sep. 22, 2023 (JP) 2023-159202

(51) Int. Cl. H04W 4/46; G01C 21/34; H04W 88/04

(52) U.S. Cl. CPC H04W 4/46; G01C 21/3492; H04W 88/04

(57) ABSTRACT

The information processing device mounted on the first vehicle performs acquisition of one or a plurality of first information including a traveling route from one or a plurality of vehicles existing in the surroundings through inter-vehicle communication, selection of a second vehicle that is scheduled to travel on at least a part of the same route as the first route on which the first vehicle is scheduled to travel from among the one or a plurality of vehicles based on the one or a plurality of first information as a relay apparatus connected by the inter-vehicle communication, and connection to the relay apparatus.

### CROSS-REFERENCE TO RELATED APPLICATION

This application claims priority to Japanese Patent Application No. 2023-159202 filed on Sep. 22, 2023, incorporated herein by reference in its entirety.

### BACKGROUND

### 1. Technical Field

The present disclosure relates to vehicle-to-vehicle communication.

### 2. Description of Related Art

There has been disclosed a vehicle position estimation device that exchanges information on a traveling direction of a vehicle by vehicle-to-vehicle communication and determines whether another vehicle is on the same traveling road as that of a target vehicle (for example, Japanese Unexamined Patent Application Publication No. 2014-109795 (JP 2014-109795 A)).

### SUMMARY

An object of the present disclosure is to provide an information processing device and a method capable of providing more stable communication to an external network through vehicle-to-vehicle communication.

An aspect of the present disclosure is an information processing device mounted on a first vehicle. The information processing device includes a control unit configured to: acquire, through vehicle-to-vehicle communication, one or more pieces of first information including a travel route from one or more vehicles present on a periphery; select, based on the one or more pieces of first information, a second vehicle from among the one or more vehicles as a relay device for connection through the vehicle-to-vehicle communication, the second vehicle being a vehicle expected to travel at least partially on the same route as a first route on which the first vehicle is expected to travel; and connect to the relay device.

Another aspect of the present disclosure is a method to be executed by an information processing device mounted on a first vehicle. The method includes: acquiring, through vehicle-to-vehicle communication, one or more pieces of first information including a travel route from one or more vehicles present on a periphery; selecting, based on the one or more pieces of first information, a second vehicle from among the one or more vehicles as a relay device for connection through the vehicle-to-vehicle communication, the second vehicle being a vehicle expected to travel at least partially on the same route as a first route on which the first vehicle is expected to travel; and connecting to the relay device.

According to the present disclosure, it is possible to provide more stable communication to the external network through vehicle-to-vehicle communication.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of an inter-vehicle communication system according to a first embodiment;

FIG. 2 is a diagram illustrating an example of a hardware configuration of a vehicle;

FIG. 3 is a diagram illustrating an exemplary functional configuration of vehicles; and

FIG. 4 is an example of a flowchart of a vehicle connection selection process.

### DETAILED DESCRIPTION OF EMBODIMENTS

For example, when the vehicle A communicates with the external network by using the vehicle B existing in the surroundings as a relay device of WiFi mesh, the vehicle A may be out of the communication range of the vehicle B due to the movement of the vehicle A and the vehicle B. In this case, the vehicle A communicates by connecting the other vehicle C as a new relay device. As described above, in communication using other vehicles such as WiFi meshes as the relay device, there is a possibility that disconnection of communication and switching of the relay device as the connection destination occur frequently.

In one aspect of the present disclosure, in view of the above problem, the vehicle selects and uses, as the relay device, a vehicle having a high possibility of being connected for a longer period from a plurality of other vehicles existing in the surroundings. More specifically, one embodiment of the present disclosure is an information processing device mounted in a vehicle. The information processing device includes a control unit that executes acquiring one or more pieces of first information including a traveling route from one or more vehicles existing in the surroundings through vehicle-to-vehicle communication, selecting, based on the one or more pieces of first information, a second vehicle that is scheduled to travel on a route at least partially the same as the first route on which the first vehicle is scheduled to travel from among the one or more vehicles, as a relay device that is connected through vehicle-to-vehicle communication, and connecting to the relay device.

The information processing device is, for example, any one of a Data Communication Module (DCM) mounted on a vehicle, an Electronic Control Unit (ECU) having an inter-vehicle communication function, a car navigation system, and the like. Further, the information processing device may include a smart phone, a Personal Computer (PC), a tablet terminal, a portable gaming machine, and the like, which may be carried by a user and loaded on vehicles. The control unit may be, for example, a processor such as Central Processing Unit (CPU) and Graphics Processing Unit (GPU), and circuitry such as Field Programmable Gate Array (FPGA).

The inter-vehicle communication is, for example, a meshed WiFi. However, the present disclosure is not limited thereto, and any communication method that supports mesh connection is applicable. Examples of a vehicle-to-vehicle communication system include Cellular Vehicle to Everything (C-V2X), Dedicated Short Range Communication (DSRC), and the like. The same route as the first route includes not only a route that perfectly matches the first route but also a similar route, for example, a route in which a part of the route from the current position of the first vehicle to a predetermined point matches, and a route traveling on a road in the vicinity of the first route.

According to one aspect of the present disclosure, connecting a second vehicle that is scheduled to travel on the same route as the first vehicle as a relay device increases the likelihood that the first vehicle will be longer within the communication range of the second vehicle, even if there is movement. Accordingly, it is possible to reduce the frequency of occurrence of disconnection and switching caused by the movement of the first vehicle in communication using another vehicle as the relay device. Therefore, according to one aspect of the present disclosure, stable communication can be provided to a first vehicle.

In one aspect of the present disclosure, the control unit may obtain one or more second information regarding the travel of the vehicle from one or more vehicles present in the surroundings. In addition, when the second vehicle does not exist, the control unit may select, as the relay device, a third vehicle having the same traveling direction as the first vehicle from among the one or more vehicles existing in the vicinity based on the one or more second information. The second information includes, for example, position information, speed, traveling direction, and the like of the vehicle. By selecting a third vehicle traveling in the same direction as the relay device, there is a high possibility that the first vehicle can be connected to the third vehicle for a longer time.

In addition, when there are a plurality of second vehicles, when there are a plurality of third vehicles, or when there are neither the second vehicle nor the third vehicle, the control unit may select, as the relay device, a vehicle that satisfies at least one of a type of lane that is the same as the type of lane in which the first vehicle is traveling, and a traveling speed that is a predetermined range from the speed of the first vehicle, based on the second information acquired from the surrounding vehicle. Examples of the lane types include a straight lane, a right turn lane, and a left turn lane. As a result, a vehicle that may travel longer in the vicinity of the first vehicle can be selected as the relay device.

Alternatively, in a case where there are a plurality of second vehicles, a plurality of third vehicles, or a case where there are neither the second vehicle nor the third vehicle, the control unit may select, as the relay device, a vehicle having a smaller number of hops to the base station or the access point, a vehicle having a smaller number of currently connected vehicles, or a vehicle having a stronger intensity of a received radio wave from the base station, the access point, or the surrounding vehicle, based on the one or more third information regarding the communication acquired from the surrounding vehicle. The third information includes, for example, the number of hops to a base station or an access point, the number of vehicles connected to the vehicle, the received radio wave intensity of radio waves received by the vehicle from other devices, and the like. Accordingly, a vehicle capable of providing more stable communication can be selected as the relay device.

As another aspect, the present disclosure can specify a process executed by each of the information processing devices as a method executed by a computer. As another aspect, the present disclosure can also be specified as a program for causing a computer to execute the above-described method and a non-transitory computer-readable recording medium on which the program is recorded.

Hereinafter, embodiments of the present disclosure will be described with reference to the drawings. The configurations of the following embodiments are illustrative, and the present disclosure is not limited to the configurations of the embodiments.

### First Embodiment

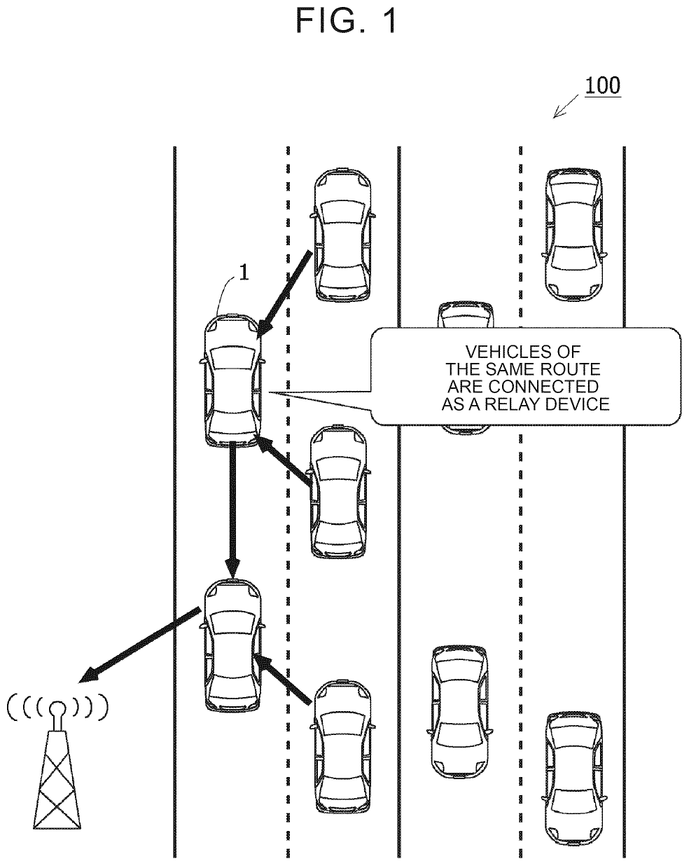

FIG. 1 is a diagram illustrating an example of a configuration of an inter-vehicle communication system 100 according to a first embodiment. The inter-vehicle communication system 100 includes a plurality of vehicles 1 that can directly communicate with each other by a predetermined communication method. Note that the term “directly communicable” indicates that communication can be performed with a device of a communication partner without any relay device being interposed therebetween. In FIG. 1, for the sake of convenience, only one vehicle is indicated with a reference numeral. Hereinafter, in a case where the vehicle is not distinguished, the vehicle 1 will be described. When distinguishing from a vehicle, a vehicle other than the target vehicle is referred to as a vehicle 1B.

In the first embodiment, vehicles 1 included in the inter-vehicle communication system 100 perform communication in a meshed WiFi. In the inter-vehicle communication system 100, a plurality of vehicles 1 operate as a relay device that relays a connection to a base station or an access point. For example, when connecting to an external network such as the Internet, the vehicle 1 selects a vehicle 1B to be used from a plurality of surrounding vehicle 1B operating as a relay device, and connects to the external network through the selected vehicle 1B.

The vehicle 1 transmits, by broadcast or multicast, vehicle travel information related to the travel of the vehicle 1, travel plan information related to the travel plan of the vehicle 1, and vehicle communication information related to the communication of the vehicle 1 at a predetermined cycle, and exchanges them with the surrounding vehicle 1B. The vehicle travel information includes, for example, position information, speed, traveling direction, and a state of a blinker of the vehicle 1. The travel plan information includes, for example, a destination set in the car navigation system of the vehicle 1 and a travel route to the destination. The vehicle communication information includes, for example, the number of hops to the base station or the access point, the base station in which the vehicle 1 is receiving radio waves, the access point, and information on other vehicles, the received radio wave intensity from each, the number of terminals in which the vehicle 1 is connected, and the like. Note that the information included in each of the vehicle travel information, the travel plan information, and the vehicle communication information is not limited to the above-described information.

In the first embodiment, the vehicle 1 selects, as the relay device, a vehicle 1B that can exist in the communication range longer, for example, in order to maintain communication with the external network for a longer period of time. More specifically, the vehicle 1 selects, based on the travel plan information received from the surrounding vehicle 1B, a relay device that uses a vehicle 1B that is scheduled to travel on the same route as the vehicle 1, connects to the vehicle 1B, and performs communication with an external network through the vehicle 1B. However, when the destination is not set in the vehicle 1 and when there is no vehicle 1B that is scheduled to travel on the same route as the vehicle 1, the vehicle 1 selects, as the relay device to be used, a vehicle 1B that can exist in the communication range for a longer time based on the vehicle travel information and the vehicle communication information received from the surrounding vehicle 1B. Accordingly, when the vehicle 1 performs communication by using the surrounding vehicle 1B as the relay device, the frequency of disconnection and switching of the communication by moving can be reduced.

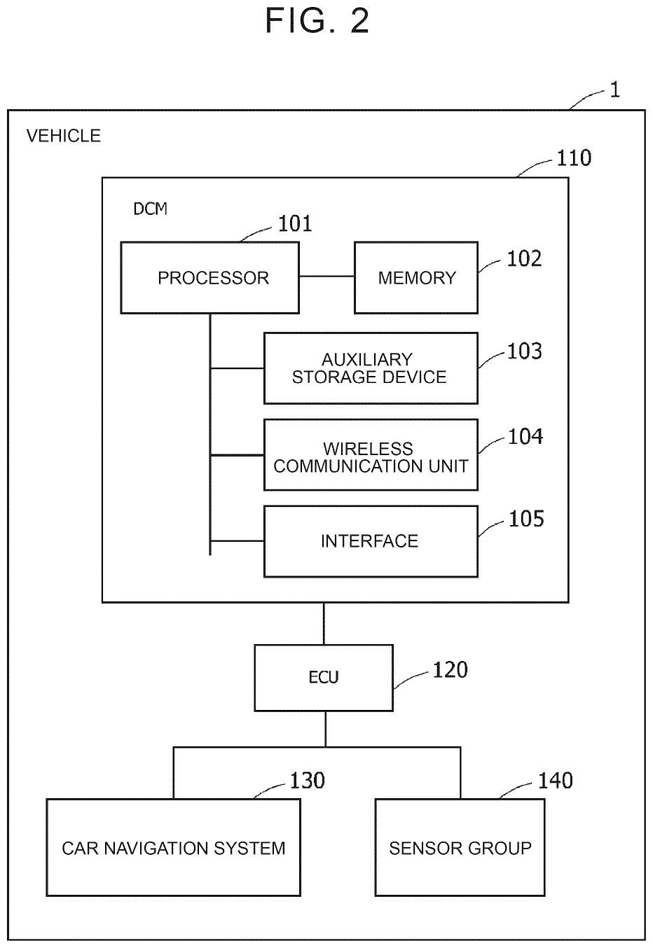

FIG. 2 is a diagram illustrating an example of a hardware configuration of the vehicle 1. Note that FIG. 2 illustrates a hardware configuration related to the inter-vehicle communication system 100 among the hardware configurations of the vehicle 1, and the hardware configuration of the vehicle 1 is not limited to the example illustrated in FIG. 2.

The vehicle 1 includes a DCM 110, ECU 120, a car navigation system 130, and a sensor group 140. DCM 110 and ECU 120 are connected by, for example, an in-vehicle LAN. ECU 120, the car navigation system 130, and the sensor group 140 are connected by, for example, a Controller Area Network (CAN).

The sensor group 140 includes, for example, sensors such as a position acquisition sensor, a speedometer, an acceleration sensor, and an azimuth sensor. The position obtaining sensor is, for example, a Global Positioning System (GPS) receiver. The position information acquired by the position acquisition sensor is, for example, latitude and longitude.

ECU 120 is, for example, an ECU or a multimedia ECU that performs a process of a center ECU, ADAS that manages ECU mounted on the vehicles 1. However, ECU 120 is not limited thereto. When ECU 120 receives a request to acquire a detection value from DCM 110 to the sensor group 140, it collects the detection values of the respective sensors from the sensor group 140 and transmits them to DCM 110.

DCM 110 is responsible for the communication function of the vehicles 1. DCM 110 includes, as a hardware configuration, a processor 101, a memory 102, an auxiliary storage device 103, a wireless communication unit 104, and interfaces 105 with an in-vehicle network. The memory 102 and the auxiliary storage device 103 are computer-readable recording media. DCM 110 is an exemplary “information processing device”.

The auxiliary storage device 103 stores various programs and data used by the processor 101 when executing the programs. The auxiliary storage device 103 is, for example, an erasable programmable read only memory (EPROM), a hard disk drive, or a solid state drive (SSD). Examples of the program stored in the auxiliary storage device 103 include an operating system (OS), an application program, and a control program for inter-vehicle communication.

The memory 102 is a storage device that provides a storage area and a work area for loading programs stored in the auxiliary storage device 103 to the processor 101, and is used as a buffer. The memory 102 includes, for example, a solid-state memory such as a read only memory (ROM), random access memory (RAM).

The processor 101 loads the program held in the auxiliary storage device 103 into the memory 102 and executes the program, thereby executing various kinds of processing. The processor 101 is, for example, a CPU, GPU or a Digital Signal Processor (DSP). The number of processors 101 is not limited to one, and a plurality of processors may be provided. The processor 101 is an example of a “control unit”.

In the first embodiment, the wireless communication unit 104 is a wireless communication circuitry of a wireless LAN. However, the wireless communication unit 104 may be a wireless communication circuit connected to a wireless network of a mobile wireless communication system such as 5G, LTE, 6G. The wireless communication unit 104 measures the radio wave intensity of the received radio wave, and detects the vehicle 1, which is the source of the radio wave having the radio wave intensity equal to or higher than a predetermined value, as a connectable device. The hardware configuration of the vehicle 1 illustrated in FIG. 2 is an example, and is not limited to the configuration illustrated in FIG. 2. DCM 110 may be a device comprising electric circuitry such as a dedicated Field-Programmable Gate Array (FPGA) or Application Specific Integrated Circuit (ASIC) for performing the process.

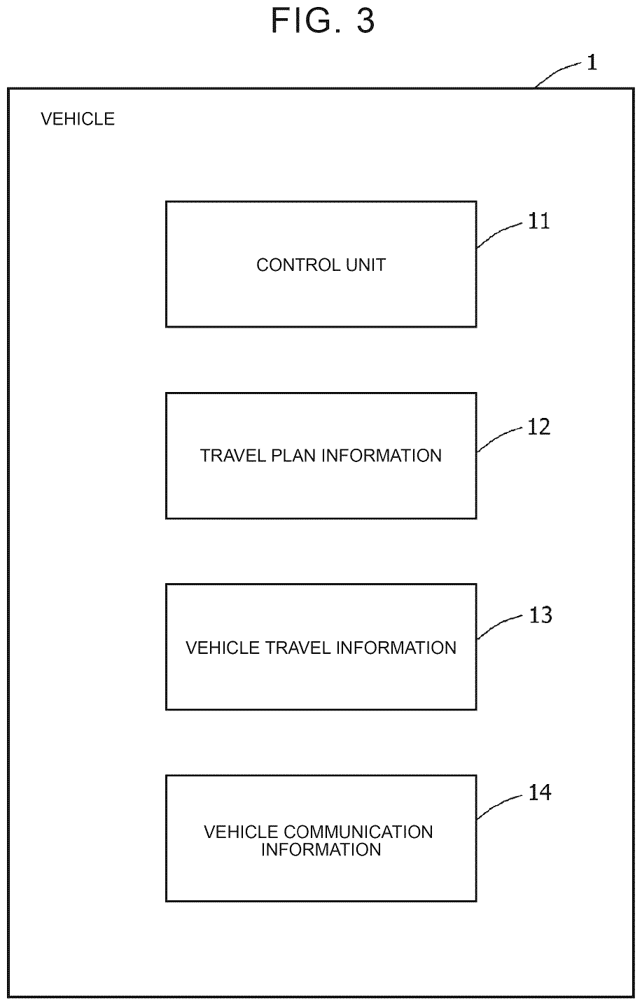

FIG. 3 is a diagram illustrating an example of a functional configuration of the vehicle 1. The vehicle 1 includes a control unit 11 as a functional configuration. Further, the vehicle 1 holds the travel plan information 12, the vehicle travel information 13, and the vehicle communication information 14 received from the other vehicle 1. The control unit 11 is a function achieved by, for example, the processor 101 of DCM 110 executing a control program for inter-vehicle communication. The vehicle 1 is an example of a “first vehicle”.

The control unit 11 generates the travel plan information, the vehicle travel information, and the vehicle communication information of the vehicle 1 on which DCM 110 is mounted at a predetermined cycle, and transmits the generated travel plan information, the vehicle travel information, and the vehicle communication information through the wireless communication unit 104 by broadcast or multicast. The travel plan information is generated by acquiring, for example, a destination and a travel route from the car navigation system 130. If the destination is not set, the travel plan information may not be created or may be empty.

The vehicle travel information is generated by acquiring detection values of the respective sensors from the sensor group 140. Note that the method of acquiring the traveling direction of the vehicle 1 included in the vehicle travel information may be any of the existing acquisition methods. In addition, the traveling direction of the vehicle 1 may be acquired by the sensor group 140 or may be calculated by DCM 110 from the sensor detection value.

The vehicle communication information is generated by acquiring, from the wireless communication unit 104, for example, identification information of the device that is the transmission source of the radio wave and the received radio wave intensity. When the travel plan information, the vehicle travel information, and the vehicle communication information are transmitted, the identification information of the vehicle 1 is also transmitted as information indicating the transmission source. The travel plan information, the vehicle travel information, and the vehicle communication information may be transmitted individually or collectively.

The control unit 11 receives the travel plan information, the vehicle travel information, and the vehicle communication information transmitted from the surrounding vehicle 1B, and stores them in the auxiliary storage device 103 as the travel plan information 12, the vehicle travel information 13, and the vehicle communication information 14, respectively. The travel plan information 12, the vehicle travel information 13, and the vehicle communication information 14 are deleted after a predetermined time has elapsed. It can be said that the vehicle 1 recognizes the presence of the vehicle 1B that is the source of the travel plan information, the vehicle travel information, and the vehicle communication information received by the vehicle 1, and that the vehicle 1 is a connectable vehicle. The travel plan information is an example of “first information”. The vehicle travel information is an example of “second information”. The vehicle communication information is an example of “third information”.

When a predetermined event occurs, the control unit 11 executes a connection destination selection process of selecting a relay device from the surrounding vehicle 1B. Examples of the event that triggers the start of the connection destination selection process include the following events. However, the event that triggers the start of the connection destination selection process is not limited to the following event.

(Event 1) A communication request to the external network occurred. (Event 2) Disconnection of connection with the relay device during communication. (Event 3) Detection of a sign that the vehicle 1B, which is a relay device in communication, is moving away.

The indication that the vehicle 1B, which is the relay device for communication, is going away is, for example, that one of the vehicle 1 and the vehicle 1B, which is the relay device, is outputting a blinker but the other is not outputting, or that both the vehicle 1 and the vehicle 1B are outputting a blinker, but the directions indicated by the blinker differ from each other. In addition, not only the condition of the blinker but also the velocity and the like of the vehicle 1 and the vehicle 1B as the relay device may be combined to detect the sign.

In the connection selection process, when the destination is set in the vehicle 1, the control unit 11 refers to the travel plan information 12 and selects the vehicle 1B that is scheduled to travel on the same travel route as the vehicle 1 as the relay device. The same traveling route as the vehicle 1 includes, in addition to a route in which the destination of the vehicle 1 and the vehicle 1B completely coincides with the route to the destination, a similar route in which some of the traveling roads are different but the vehicle 1 travels on a road parallel to the traveling road, and a route in which some of the traveling roads from the current point to a predetermined point such as a relay point are the same, although the destination is different. For example, the higher the distance coinciding with the route from the present point of the vehicle 1, the higher the priority of the vehicle 1B may be. Alternatively, the higher the similarity with the route of the vehicle 1, the higher the priorities of the vehicle 1B may be. The vehicle 1B that is scheduled to travel on the same travel route as the vehicle 1 is an exemplary “second vehicle”.

When the destination is not set in the vehicle 1, and when there is no vehicle 1B that is scheduled to travel on the same travel route as the vehicle 1, the control unit 11 refers to the travel plan information 12 and the vehicle travel information 13, and selects the vehicle 1B having the same travel direction as the vehicle 1 as the relay device. When the travel route is included in the travel plan information 12, the travel direction of the vehicle 1B may be determined from the travel route. Thus, for example, an oncoming vehicle or the like can be excluded from the option of the relay device. The vehicle 1B having the same traveling direction as the vehicle 1 is an exemplary “third vehicle”.

When the vehicle 1B as the relay device is not determined even under the above-described conditions, the control unit 11 selects the vehicle 1B as the relay device by prioritizing the surrounding vehicle 1B, for example, using the following conditions. Conditions 1 to 5 below are conditions for increasing the priority. The following conditions 1 to 5 may be used in any one or more combination. When a plurality of combinations is used, the order of determination of the conditions may be any order.

(Condition 1) Vehicle 1 is running on the same type of lane as the type of lane on which it is running. For example, lane types include a straight lane, a right turn lane, and a left turn lane. When the vehicle 1 is traveling on the straight lane, the vehicle 1B traveling on the right turn lane or the left turn lane is excluded. When the vehicle 1 is traveling on the right turning lane, the vehicle 1B traveling on the straight lane or the left turning lane is excluded. When the vehicle 1 is traveling on the left turning lane, the vehicle 1B traveling on the straight lane or the right turning lane is excluded.

(Condition 2) The traveling speed is within ±α of the traveling speed of the vehicle 1.
(Condition 3) The number of hops to the base station or the access point is smaller.
(Condition 4) The number of vehicles being connected is smaller.
(Condition 5) The radio wave strength with respect to the base station, the access point, and the surrounding vehicle 1B shall be stronger.

Conditions 1 and 2 are conditions under which the vehicle 1B is prioritized, which may be longer in the surroundings of vehicle 1. Conditions 1 and 2 are determined based on, for example, vehicle travel information 13. Conditions 3 to 5 are conditions under which the priorities of the vehicle 1B capable of providing more stable communication become higher. Conditions 3 to 5 are determined based on, for example, vehicle communication information 14. The above conditions 1 to 5 are conditions for increasing the priority, but conditions for decreasing the priority may be set, or conditions for increasing the priority and conditions for decreasing the priority may be mixed.

For example, the control unit 11 may acquire a score for each of the surrounding vehicle 1B with respect to the conditions 1 to 5, and determine the priorities of the surrounding vehicle 1B based on the sum of the scores. The scores obtained for conditions 1 to 5 may indicate that the higher the priority, or the higher the priority, the court may indicate.

After selecting the vehicle 1B to be used as the relay device by the connection selection process, the control unit 11 executes a process for connecting to the selected vehicle 1B or switching the connection. Note that the functional configuration of the vehicle 1 is not limited to the example illustrated in FIG. 3.

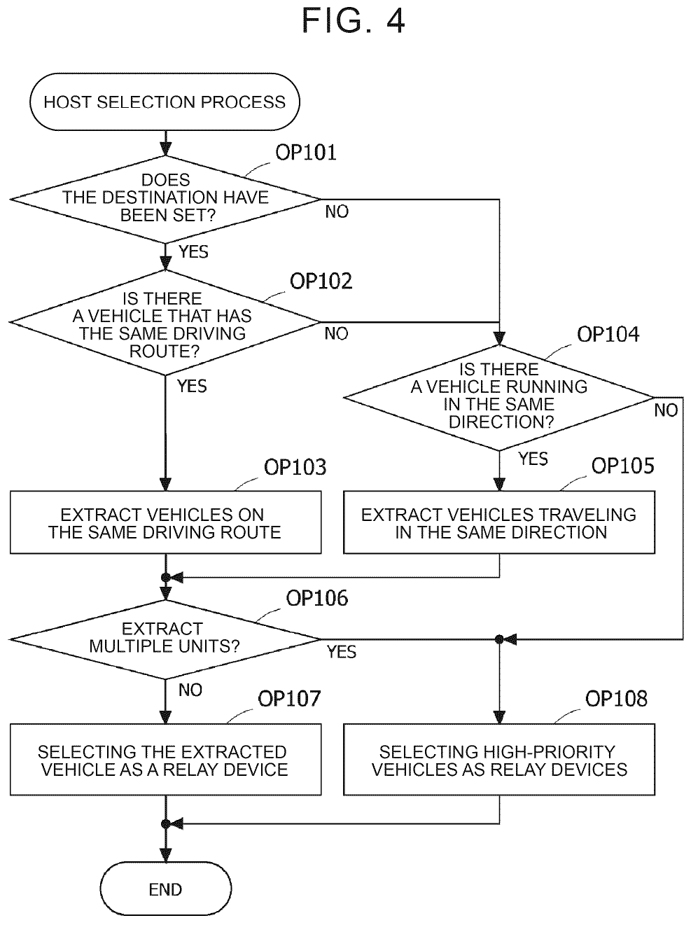

FIG. 4 is an example of a flowchart of a connection selection process of the vehicle 1. The process illustrated in FIG. 4 is started when an event that is a start trigger occurs. Although the processor 101 of DCM 110 is an executing entity of the process illustrated in FIG. 4, for convenience, the functional components will be mainly described.

In OP101, the control unit 11 determines whether or not a destination is set in the car navigation system 130. When a destination is set in the car navigation system 130, there is information on a traveling route to the destination to which the vehicle 1 is scheduled to travel in the future. When the destination is not set in the car navigation system 130, there is no information about a route on which the vehicle 1 is scheduled to travel in the future. If the destination is set (OP101: YES), the process proceeds to OP102. If the destination is not set (OP101: NO), the process proceeds to OP104.

In OP102, the control unit 11 determines, based on the travel plan information 12, whether or not the vehicle 1 and the vehicle 1B having the same travel route in the future are located in the surroundings. When the vehicle 1B in which the vehicle 1 and the driving route in the future are the same are surrounded (OP102: YES), the process advances to OP103. In OP103, the control unit 11 extracts the vehicle 1B having the same driving route as the vehicle 1 in the future.

When there is no vehicle 1B in which the vehicle 1 and the driving route in the future are the same (OP102: NO), the process proceeds to OP104. In OP104, the control unit 11 determines, based on the vehicle travel information 13, whether or not the vehicle 1B having the same travel direction as that of the vehicle 1 is located in the surroundings. When the vehicle 1B having the same traveling direction as the vehicle 1 is around (OP104: YES), the process proceeds to OP105. In OP105, the control unit 11 extracts the vehicle 1B having the same travel direction as that of the vehicle 1. When the vehicle 1B having the same traveling direction as the vehicle 1 is not located in the surroundings (OP104: NO), the process proceeds to OP108.

In OP106, the control unit 11 determines whether or not there are a plurality of vehicles 1B extracted by OP103 or OP105. If there is a plurality of vehicles 1B extracted by OP103 or OP105 (OP106: YES), the process proceeds to OP108. When the vehicle 1B extracted by OP103 or OP105 is not plural (OP106: NO), the process proceeds to OP107.

In OP107, the control unit 11 selects one vehicle 1B extracted by OP103 or OP105 as a relay device. After that, the process shown in FIG. 4 ends. In OP108, the control unit 11 assigns priorities to the plurality of vehicles 1B extracted by OP103 or OP105 using, for example, the above-described conditions 1 to 5, and selects the vehicle 1B with the highest priority as the relay device. After that, the process shown in FIG. 4 ends.

### Action Effect of First Embodiment

In the first embodiment, when communication is performed using the surrounding vehicle 1B as a relay device, the vehicle 1 selects a relay device that uses a vehicle 1B that may exist in a communication range for a longer period of time, such as a vehicle 1B having the same traveling route or traveling direction. As a result, it is possible to reduce the frequency of disconnection from the vehicle 1B that is the relay device or switching to another vehicle 1B during communication, and thus it is possible to provide more stable communication.

### Other Embodiments

The above-described embodiment is merely an example, and the present disclosure may be appropriately modified and implemented without departing from the scope thereof.

The technique described in the first embodiment is applied to vehicle-to-vehicle communication, and the destination selection process is executed by a DCM 110 mounted on the vehicle 1, but is not limited thereto. For example, the present disclosure is applicable to communication between user terminals such as a smart phone, a tablet terminal, a wearable terminal, and a PC carried by an occupant of the vehicle 1 and between the user terminal and the vehicle, and the connection destination selection process may be executed by these terminals. In this case, the travel plan information, the vehicle travel information, and the information included in the vehicle communication information created by the user terminal may be appropriately replaced with information that can be acquired by the user terminal.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device mounted on a first vehicle, the information processing device comprising a control unit configured to:
acquire, through vehicle-to-vehicle communication, one or more pieces of first information including a travel route from one or more vehicles present on a periphery;
select, based on the one or more pieces of first information, a second vehicle from among the one or more vehicles as a relay device for connection through the vehicle-to-vehicle communication, the second vehicle being a vehicle expected to travel at least partially on the same route as a first route on which the first vehicle is expected to travel; and
connect to the relay device.

2. The information processing device according to claim 1, wherein the control unit is configured to:
acquire, through the vehicle-to-vehicle communication, one or more pieces of second information on vehicle travel from the one or more vehicles; and
select, when the second vehicle is not present, a third vehicle from among the one or more vehicles as the relay device based on the one or more pieces of second information, the third vehicle being a vehicle traveling in the same traveling direction as the first vehicle.

3. The information processing device according to claim 2, wherein the control unit is configured to when a plurality of the second vehicles is present, a plurality of the third vehicles is present, or neither the second vehicle nor the third vehicle is present, select, as the relay device, a vehicle satisfying at least one of a condition that the vehicle is traveling in a lane of the same type as a type of a lane in which the first vehicle is traveling and a condition that a traveling speed is within a predetermined range from a speed of the first vehicle from among the second vehicles, the third vehicles, or the one or more vehicles based on the one or more pieces of second information.

4. The information processing device according to claim 2, wherein the control unit is configured to:
acquire, through the vehicle-to-vehicle communication, one or more pieces of third information on communication from the one or more vehicles; and
when a plurality of the second vehicles is present, a plurality of the third vehicles is present, or neither the second vehicle nor the third vehicle is present, select, as the relay device, a vehicle having a smaller number of hops to a base station or an access point, a vehicle having a smaller number of currently connected vehicles, or a vehicle having a stronger intensity of a received radio wave from a base station, an access point, or a surrounding vehicle from among the second vehicles, the third vehicles, or the one or more vehicles based on the one or more pieces of third information.

5. A method to be executed by an information processing device mounted on a first vehicle, the method comprising:
acquiring, through vehicle-to-vehicle communication, one or more pieces of first information including a travel route from one or more vehicles present on a periphery;
selecting, based on the one or more pieces of first information, a second vehicle from among the one or more vehicles as a relay device for connection through the vehicle-to-vehicle communication, the second vehicle being a vehicle expected to travel at least partially on the same route as a first route on which the first vehicle is expected to travel; and
connecting to the relay device.
